(19) United States
(12) Patent Application Publication
(10) Pub. No.: US 2026/0179641 A1
(43) Pub. Date: Jun. 25, 2026

(54) METHOD FOR NOISE REDUCTION IN EARPHONE CALLS AND EARPHONE

(71) Applicant: Bestechnic (Shanghai) Co., Ltd., Shanghai (CN)

(72) Inventors: Jinfeng GU, Shanghai (CN); Zhihao ZHU, Shanghai (CN); Qian LI, Shanghai (CN)

(73) Assignee: Bestechnic (Shanghai) Co., Ltd., Shanghai (CN)

(21) Appl. No.: 19/433,561

(22) Filed: Dec. 26, 2025

Related U.S. Application Data
(63) Continuation of application No. PCT/CN2025/131218, filed on Oct. 30, 2025.

(30) Foreign Application Priority Data
Dec. 24, 2024 (CN) 202411915737.6

(51) Int. Cl. G10L 21/0232; G10L 21/0216; G10L 25/18; G10L 25/21; G10L 25/84; H04R 1/10

(52) U.S. Cl. CPC G10L 21/0232; G10L 25/18; G10L 25/21; G10L 25/84; H04R 1/1083; G10L 2021/02165; H04R 2460/01

(57) ABSTRACT

An earphone call noise reduction method, an earphone, and a non-transitory computer-readable medium are provided. The method includes: acquiring a first sound signal inside a human ear through a first microphone and a second sound signal outside the human ear through a second microphone; performing target conversion processing on the first sound signal to obtain a first audio frame and on the second sound signal to obtain a second audio frame; performing adaptive filtering processing on the first audio frame based on the second audio frame to obtain a third audio frame; adjusting the third audio frame according to attribute information to obtain an in-ear resultant sound signal; adjusting the second audio frame according to the attribute information to obtain an out-ear resultant sound signal; and generating a target sound signal by fusing the in-ear resultant sound signal and the out-ear resultant sound signal.

### CROSS-REFERENCE TO RELATED APPLICATIONS

This application is a continuation of International Application No. PCT/CN2025/131218, filed on Oct. 30, 2025, which claims the benefit of priority to Chinese Application No. 202411915737.6, filed on Dec. 24, 2024, both of which are incorporated herein by reference in their entireties.

### TECHNICAL FIELD

The present application relates to the field of audio processing technologies, and in particular, to a method for noise reduction in earphone calls and an earphone.

### BACKGROUND

With the widespread adoption of earphones in the market, the use of earphones for answering calls, voice conversations, and participating in meetings has become increasingly common in environments such as offices, noisy shopping malls, and public transportation like buses and subways. However, in real-world call scenarios, numerous external noises—such as wind, sudden mechanical noises, and disruptive human voices—are often present. These noises can cause the speech signal to be overwhelmed by the background noise, severely compromising the user's call experience.

### SUMMARY

The present application provides an earphone call noise reduction method, an earphone, and a non-transitory computer-readable medium. The third audio frame and the second audio frame are adjusted based on attribute information of the third audio frame to optimize the noise reduction performance of the earphone.

In a first aspect, an earphone call noise reduction method is provided, includes: acquiring a first sound signal inside a human ear through a first microphone of an earphone, and acquiring a second sound signal outside the human ear through a second microphone of the earphone; performing target conversion processing on the first sound signal to obtain a first audio frame, and performing the target conversion processing on the second sound signal to obtain a second audio frame. The target conversion processing includes framing, windowing, and Fourier transform. The method further includes: performing adaptive filtering processing on the first audio frame based on the second audio frame to obtain a third audio frame; adjusting the third audio frame according to attribute information of the third audio frame to obtain an in-ear resultant sound signal. The attribute information includes: noise presence information, interfering human voice presence information, and target human voice presence information. The method further includes: adjusting the second audio frame according to the attribute information to obtain an out-ear resultant sound signal; performing signal fusion processing on the in-ear resultant sound signal and the out-ear resultant sound signal, and generating a target sound signal to be output based on a result of the signal fusion processing.

In a second aspect, an earphone is provided. The earphone includes: a first microphone configured to collect a first sound signal inside a human ear; a second microphone configured to collect a second sound signal outside the human ear; and a processing unit coupled to the first microphone and the second microphone, configured to execute the earphone call noise reduction method according to any embodiment of the first aspect.

In a third aspect, a non-transitory computer-readable medium is provided. The non-transitory computer-readable medium storing instructions that, when executed by a processor, cause the processor to perform the earphone call noise reduction method according to any embodiment of the first aspect.

By applying the above technical solution, the first sound signal inside the human ear is acquired through the first microphone of the earphone, and the second sound signal outside the human ear is acquired through the second microphone of the earphone. Target conversion processing, including framing, windowing, or Fourier transform, is performed on the first sound signal to obtain the first audio frame and on the second sound signal to obtain the second audio frame. Adaptive filtering processing is performed on the first audio frame based on the second audio frame to obtain the third audio frame. The third audio frame is adjusted according to its attribute information-including noise presence information, interfering human voice presence information, or target human voice presence information—to obtain the in-ear resultant sound signal. The second audio frame is adjusted according to the attribute information to obtain the out-ear resultant sound signal. Signal fusion processing is performed on the in-ear and out-ear resultant sound signals, and the target sound signal to be output is generated based on the result of the signal fusion processing. Since the attribute information includes noise presence information, interfering human voice presence information, or target human voice presence information, noise reduction is performed according to the actual presence of noise and interfering human voices, thereby optimizing the noise reduction effect, improving earphone call quality, and enhancing user experience.

### BRIEF DESCRIPTION OF THE DRAWINGS

The accompanying drawings, which are incorporated herein and form a part of the specification, illustrate aspects of the present disclosure and, together with the description, further serve to explain the principles of the present disclosure and to enable a person skilled in the pertinent art to make and use the present disclosure.

It is noted that the drawings in the present application are not necessarily drawn to scale, the same reference numerals may be used in different views to describe similar components. Identical reference numerals with letter suffixes or differing suffixes may denote different instances of similar components. The same reference numerals used across all figures may refer to the same or similar parts. However, these embodiments are illustrative and are not intended to be exhaustive or exclusive representations of the apparatus or method.

FIG. 1 illustrates a first flowchart of a method for noise reduction in earphone calls according to some implementations of the present application;

FIG. 2 illustrates a flowchart of determining attribute information of a third audio frame according to some implementations of the present application;

FIG. 3 illustrates a flowchart of adjusting a third audio frame according to some implementations of the present application;

FIG. 4 illustrates a first flowchart of determining an out-of-ear result sound signal according to some implementations of the present application;

FIG. 5 illustrates a second flowchart of determining an out-of-ear result sound signal according to some implementations of the present application;

FIG. 6 illustrates a second flowchart of a method for noise reduction in earphone calls according to some implementations of the present application;

FIG. 7 illustrates a third flowchart of a method for noise reduction in earphone calls according to some implementations of the present application; and

FIG. 8 illustrates a structural block diagram of an earphone according to some implementations of the present application.

The present disclosure will be described with reference to the accompanying drawings.

### DETAILED DESCRIPTION

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present disclosure.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Specific embodiments of the present application are described hereafter with reference to the drawings; however, it is to be understood that the disclosed embodiments are merely examples of the application, which may be embodied in various forms. Well-known and/or repetitive functions and constructions are not described in detail to avoid obscuring the application with unnecessary or redundant details. Consequently, specific structural and functional details disclosed herein are not to be interpreted as limiting, but merely as implementations or examples for the claims and as a representative basis for teaching one skilled in the art to variously employ the present application in any appropriately detailed structure.

The description may use the phrases “in one embodiment,” “in another embodiment,” “in yet another embodiment,” “in other embodiments,” “in one implementations,” “in some implementations,” “in one example,” or “in some examples” which may each refer to one or more of the same or different embodiments in accordance with the present application.

A noise reduction method for an earphone call according to some implementations of the present application includes: acquiring a first sound signal from inside a human ear via a first microphone of the earphone; acquiring a second sound signal from outside the human ear via a second microphone of the earphone; performing adaptive filtering processing on a first audio frame corresponding to the first sound signal based on a second audio frame corresponding to the second sound signal, so as to improve the signal-to-noise ratio of the first audio frame and obtain a third audio frame; subsequently adjusting the third audio frame and the second audio frame respectively according to attribute information of the third audio frame, to obtain an in-ear result sound signal and an out-of-ear result sound signal, and performing signal fusion processing thereon; and generating a target sound signal to be output based on a result of the signal fusion processing. Since the attribute information includes noise presence information, interfering human voice presence information, and target voice presence information, noise reduction processing is implemented according to the actual presence of noise and interfering human voices, thereby optimizing the noise reduction effect and significantly enhancing the call quality of the earphone.

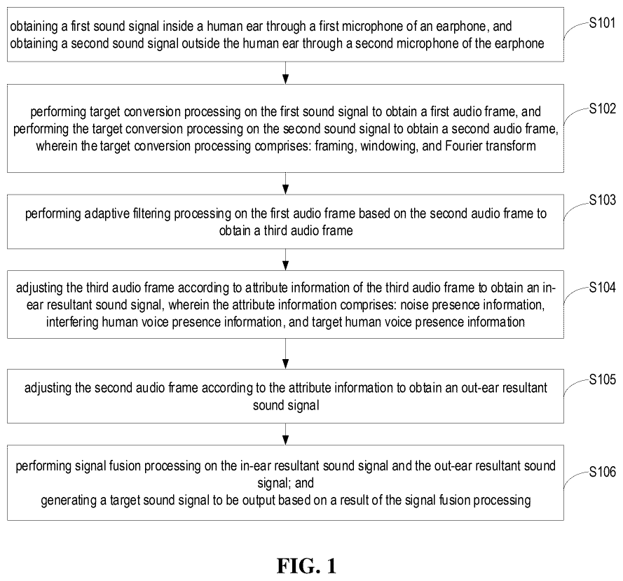

FIG. 1 illustrates a first flowchart of a method for noise reduced during call in earphones according to an implementation of the present application. As shown in FIG. 1, the method includes the following steps:

Step S101: Acquire a first sound signal from inside a human ear through a first microphone of the earphone, and acquire a second sound signal from outside the human ear through a second microphone of the earphone.

In this implementation, the earphone is provided with at least one first microphone and at least one second microphone. The first microphone and the second microphone may be digital microphones or analog microphones.

After a user wears the earphone, the first microphone may be located inside the ear canal of the human ear. The signal collected by the first microphone primarily contains the target voice signal, but may also include surrounding environmental noise leaked to varying degrees depending on the wearing manner. The signal characteristics include a high signal-to-noise ratio in low frequencies and severe attenuation of high-frequency components. The second microphone is generally exposed to the external acoustic environment and can collect surrounding speech and complex environmental noise. The user's voice is transmitted to the second microphone through the air.

The first sound signal from inside the human ear may be acquired through the first microphone, and the second sound signal from outside the human ear may be acquired through the second microphone, in real-time, or when the user is on a call using the earphone.

In some implementations of the present application, the second microphone may be a single Talk microphone, a single FF microphone (i.e., a feedforward microphone), or a dual-microphone system. In the case of a dual-microphone system, the second sound signal is obtained by performing beamforming processing on the signals from the dual microphones.

Step S102: Perform a target conversion process on the first sound signal to obtain a first audio frame, and perform the target conversion process on the second sound signal to obtain a second audio frame. The target conversion process includes framing, windowing, or Fourier transform.

In this implementation, to facilitate subsequent noise reduction processing, the first sound signal and the second sound signal are respectively subjected to framing, windowing, or Fourier transform to convert the first sound signal and the second sound signal into the frequency domain, thereby obtaining a first audio frame corresponding to the first sound signal and a second audio frame corresponding to the second sound signal.

Step S103: Perform adaptive filtering processing on the first audio frame based on the second audio frame to obtain a third audio frame.

In this implementation, adaptive filtering processing is performed on the first audio frame using an adaptive filter based on the second audio frame to obtain a third audio frame. This dynamically adjusts the first audio frame according to the second audio frame, eliminating environmental noise leaked into the first microphone due to improper wearing (or varying degrees of wearing tightness) by the user, thereby improving the signal-to-noise ratio of the first audio frame.

Step S104: Adjust the third audio frame according to attribute information of the third audio frame to obtain an in-ear result sound signal. The attribute information includes noise presence information, interfering human voice presence information, and target voice presence information.

In this implementation, noise refers to environmental noise, interfering human voice refers to voices other than the user's speech, and target voice refers to the user's speech. The attribute information of the third audio frame is determined, which includes noise presence information, interfering human voice presence information, and target voice presence information. The third audio frame is adjusted based on this attribute information to reduce noise and interfering human voice in the third audio frame, and the adjusted third audio frame is taken as the in-ear result sound signal.

Step S105: Adjust the second audio frame based on the attribute information to obtain an out-ear resultant sound signal.

Adjust the second audio frame according to the attribute information to reduce noise and interfering human voices in the second audio frame, and use the adjusted second audio frame as the out-ear resultant sound signal.

It is understandable that the execution order of Step S104 and Step S105 is not limited.

Step S106: Perform signal fusion processing on the in-ear resultant sound signal and the out-ear resultant sound signal, and generate a target sound signal to be output based on the result of the signal fusion processing.

In this implementation, after obtaining the in-ear resultant sound signal and the out-ear resultant sound signal, signal fusion processing is performed on them. For example, the in-ear resultant sound signal and the out-ear resultant sound signal may be directly fused, or they may be weighted before fusion. Thereafter, the target sound signal to be output is generated based on the result of the signal fusion processing. Subsequently, the target sound signal may be output as an uplink voice signal.

In some implementations of the present application, generating the target sound signal to be output based on the result of the signal fusion processing includes: performing an inverse Fourier transform on the result of the signal fusion processing to obtain the target sound signal, thereby ensuring that the target sound signal is subsequently output in the form of a time-domain signal.

The earphone call noise reduction method of the implementations of the present application includes: obtaining a first sound signal inside the human ear through a first microphone of the earphone and a second sound signal outside the human ear through a second microphone of the earphone; performing target conversion processing on the first sound signal to obtain a first audio frame, and performing target conversion processing on the second sound signal to obtain a second audio frame, where the target conversion processing includes framing, windowing, or Fourier transform; performing adaptive filtering processing on the first audio frame based on the second audio frame to obtain a third audio frame; adjusting the third audio frame according to the attribute information of the third audio frame to obtain an in-ear resultant sound signal, where the attribute information includes noise presence information, interfering human voice presence information, and target human voice presence information; adjusting the second audio frame according to the attribute information to obtain an out-ear resultant sound signal; and performing signal fusion processing on the in-ear resultant sound signal and the out-ear resultant sound signal, and generating a target sound signal to be output based on the result of the signal fusion processing. Since the attribute information includes noise presence information, interfering human voice presence information, and target human voice presence information, noise reduction processing is implemented according to the actual presence of noise and interfering human voices, thereby effectively suppressing loud noise and interfering human voices, improving call clarity and intelligibility, and perfectly restoring the natural timbre of the target voice, thus enhancing user experience.

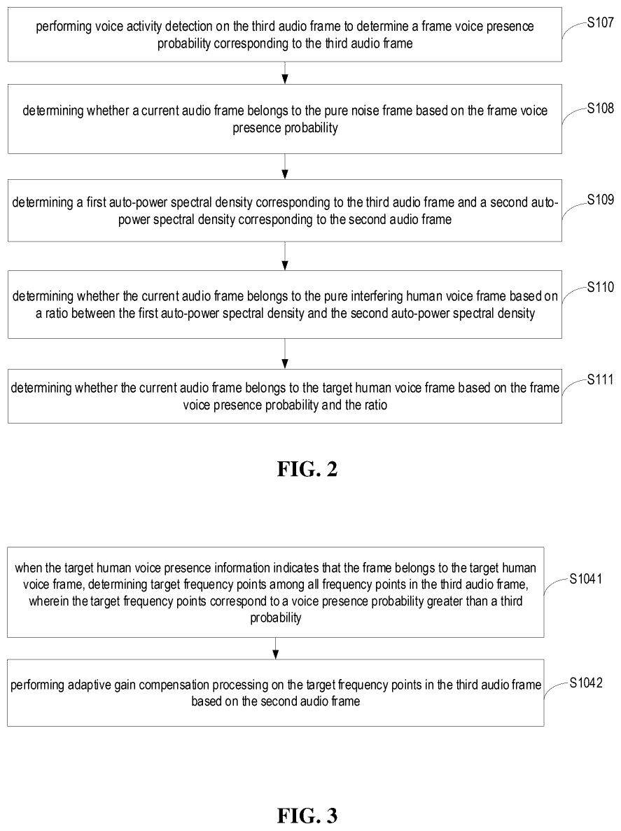

In some implementations of the present application, the noise presence information includes whether it is a pure noise frame, the interfering human voice presence information includes whether it is a pure interfering human voice frame, and the target human voice presence information includes whether it is a target human voice frame. FIG. 2 illustrates a flowchart of determining attribute information of the third audio frame according to an implementation of the present application. Before adjusting the third audio frame according to the attribute information of the third audio frame, as shown in FIG. 2, the method further includes the following steps:

Step S107: Perform voice activity detection on the third audio frame to determine a frame voice presence probability corresponding to the third audio frame.

In this implementation, noise estimation may be performed on the third audio frame, and the frame voice presence probability of the third audio frame may be determined based on the noise estimation result. In some implementations, a neural network may be used to process the third audio frame to output a voice activity result and determine the frame voice presence probability.

In some implementations of the present application, performing voice activity detection on the third audio frame may include performing voice activity detection on each frequency point in the third audio frame to determine a voice presence probability of each frequency point, and then determining the frame voice presence probability based on the voice presence probability of each frequency point. For example, the average value of the voice presence probabilities of all frequency points may be determined as the frame voice presence probability.

Step S108: Determine whether the current audio frame belongs to the pure noise frame based on the frame voice presence probability.

In this implementation, the current audio frame corresponds to the third audio frame and the second audio frame, meaning that the third audio frame and the second audio frame should share the same attribute information. If the current audio frame belongs to a pure noise frame, it indicates that the wearer is not speaking and only environmental noise is present. Whether the current audio frame belongs to a pure noise frame can be determined based on the frame voice presence probability.

Step S109: Determine a first auto-power spectral density corresponding to the third audio frame and a second auto-power spectral density corresponding to the second audio frame.

In this implementation, the presence of interfering human voices is determined by comparing the energy of the third audio frame and the second audio frame. The auto-power spectral density is a function reflecting the power distribution of a random signal in the frequency domain, describing the power density of the signal at different frequencies, i.e., the power per unit frequency range. Various methods can be employed to determine the auto-power spectral density, such as the periodogram method, averaged periodogram method, Welch's method, and autocorrelation method.

The first auto-power spectral density corresponding to the third audio frame and the second auto-power spectral density corresponding to the second audio frame are determined. Subsequently, interfering human voice detection is performed using the first and second auto-power spectral densities.

Step S110: Determine whether the current audio frame belongs to the pure interfering human voice frame based on a ratio between the first auto-power spectral density and the second auto-power spectral density.

In this implementation, a pure interfering human voice frame indicates that only interfering human voices are present in the current audio frame. The ratio between the first auto-power spectral density and the second auto-power spectral density is determined, and based on this ratio, it is assessed whether the current audio frame belongs to a pure interfering human voice frame.

Step S111: Determine whether the current audio frame belongs to the target human voice frame based on the frame voice presence probability and the ratio.

In this implementation, a target human voice frame indicates that the current audio frame contains target speech uttered by the user. Whether the current audio frame belongs to a target human voice frame is determined based on the frame voice presence probability and the ratio.

Voice activity detection is performed to determine the frame voice presence probability, while interfering human voice detection is conducted using the auto-power spectral densities corresponding to the third audio frame and the second audio frame. This enables efficient and accurate determination of the attribute information of the third audio frame.

In some implementations of the present application, the current audio frame belongs to the pure noise frame when the frame voice presence probability is less than a first probability; the current audio frame belongs to the pure interfering human voice frame when the ratio is less than a first ratio; and the current audio frame belongs to the target human voice frame when the frame voice presence probability is greater than a second probability and the ratio is greater than a second ratio. The first probability is less than the second probability, and the first ratio is less than the second ratio.

The first auto-power spectral density is the auto-power spectral density of the third audio frame within a target frequency range, and the second auto-power spectral density is the auto-power spectral density of the second audio frame within the target frequency range.

In this implementation, the frame voice presence probability is compared with the first probability and the second probability, and the ratio is compared with the first ratio and the second ratio. If the frame voice presence probability is less than the first probability, it indicates a low probability of voice presence in the current frame, and thus the current audio frame is determined to be a pure noise frame. If the ratio is less than the first ratio, it indicates the absence of target human voice, and thus the current audio frame is determined to be a pure interfering human voice frame. If the frame voice presence probability is greater than the second probability and the ratio is greater than the second ratio, it indicates the presence of target human voice, and thus the current audio frame is determined to be a target human voice frame. This enables more efficient determination of the attribute information.

Additionally, the target frequency range may be determined based on the frequency range of the wearer's jawbone vibration signal and the sensitivity of the first microphone. For example, the frequency range of jawbone vibration signals during human speech typically may fall between 100 Hz and 1.5 kHz. Thus, the target frequency range may be set to 100 Hz to 1.5 kHz, while auto-power spectral densities outside this target frequency range are not processed. Since the first auto-power spectral density is the auto-power spectral density of the third audio frame within the target frequency range, and the second auto-power spectral density is the auto-power spectral density of the second audio frame within the target frequency range, the calculation of ratios for auto-power spectral densities outside the target frequency range is avoided. This reduces computational load and prevents misjudgments caused by high-frequency attenuation and noise in the first microphone's signal, thereby significantly improving the accuracy of interfering human voice detection.

In some implementations of the present application, the ratio is determined using Formula 1, which is specifically expressed as follows:

$$Energy\_diff = \frac{{\sum }_{{ω}_{2}}^{{ω}_{1}} {Φ}_{F B} ( ω )}{{\sum }_{{ω}_{2}}^{{ω}_{1}} {Φ}_{OUT} ( ω ) + δ}$$

where, Energy_diff represents the ratio, Φ_FB (ω) represents the first auto-power spectral density, Φ_OUT (ω) represents the second auto-power spectral density, and ω represents the angular frequency; δ is a small quantity greater than 0 to avoid division by zero; ω₁ and ω₂ represent the upper and lower limits of the target frequency range, respectively, with the minimum value of ω₁ being 0 and the maximum value of ω₂ being ½ of the FFT (Fast Fourier Transform) points.

The ratio is determined using Formula 1, thereby further improving the accuracy of interfering human voice detection.

FIG. 3 illustrates a flowchart of adjusting the third audio frame according to an implementation of the present application. Adjusting the third audio frame based on the attribute information of the third audio frame, as shown in FIG. 3, includes the following steps:

Step S1041: In a case where the target human voice presence information indicates that the frame belongs to the target human voice frame, determine target frequency points among all frequency points in the third audio frame, where the target frequency points correspond to a voice presence probability greater than a third probability.

In this implementation, when the target human voice presence information indicates that the frame belongs to the target human voice frame, the voice presence probability of each frequency point in the third audio frame is determined. Frequency points with a voice presence probability greater than the third probability are identified as target frequency points. Subsequently, adaptive gain compensation processing is applied only to these target frequency points.

In some implementations, the third probability may be the same as or different from the first probability.

Step S1042: Perform adaptive gain compensation processing on the target frequency points in the third audio frame based on the second audio frame.

In this implementation, adaptive gain compensation processing is applied to the target frequency points in the third audio frame based on the second audio frame. This automatically adjusts the gain of the target frequency points according to the frequency response characteristics of the second audio frame, ensuring that the gain of the target frequency points remains at an appropriate level.

By identifying the target frequency points, amplification of noise frequency points in the third audio frame can be avoided. Applying adaptive gain compensation processing only to the target frequency points perfectly restores the natural timbre of the target human voice, thereby enhancing the user's call experience.

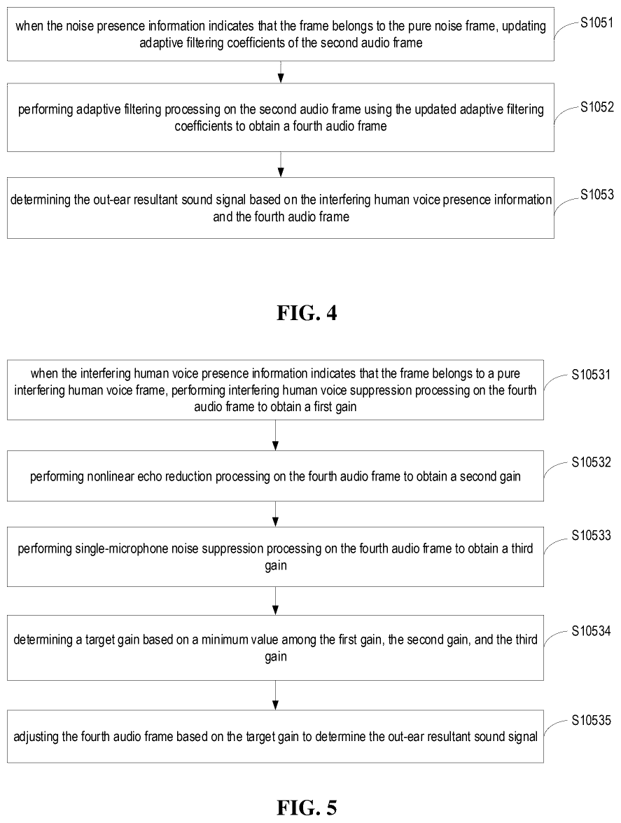

FIG. 4 illustrates a first flowchart of determining the out-ear resultant sound signal according to an implementation of the present application. Adjusting the second audio frame based on the attribute information to obtain the out-ear resultant sound signal, as shown in FIG. 4, includes the following steps:

Step S1051: In a case where the noise presence information indicates that the frame belongs to the pure noise frame, update adaptive filtering coefficients of the second audio frame.

In this implementation, if the noise presence information indicates that the frame belongs to a pure noise frame, it means the current audio frame is a pure noise frame. Accordingly, the adaptive filtering coefficients of the second audio frame are updated.

Step S1052: Perform adaptive filtering processing on the second audio frame using the updated adaptive filtering coefficients to obtain a fourth audio frame.

In this implementation, adaptive filtering processing is performed on the second audio frame using an adaptive filter with the updated adaptive filtering coefficients. This accurately and effectively filters out noise in the second audio frame, resulting in the fourth audio frame.

Step S1053: Determine the out-ear resultant sound signal based on the interfering human voice presence information and the fourth audio frame.

The fourth audio frame is further adjusted according to the interfering human voice presence information to determine the out-ear resultant sound signal.

By updating the adaptive filtering coefficients of the second audio frame when the noise presence information indicates a pure noise frame, the updated adaptive filtering coefficients better match the actual noise presence conditions. This enables more accurate noise filtering in the second audio frame. Additionally, through the interfering human voice presence information, interfering human voices in the fourth audio frame can be effectively suppressed, thereby improving the quality of the out-ear resultant sound signal.

FIG. 5 illustrates a second flowchart of determining the out-ear resultant sound signal according to an implementation of the present application. Determining the out-ear resultant sound signal based on the interfering human voice presence information and the fourth audio frame, as shown in FIG. 5, includes the following steps:

Step S10531: In a case where the interfering human voice presence information indicates that the frame belongs to a pure interfering human voice frame, perform interfering human voice suppression processing on the fourth audio frame to obtain a first gain.

In this implementation, if the interfering human voice presence information indicates that the frame belongs to a pure interfering human voice frame, it is determined that the current audio frame is a pure interfering human voice frame. Interfering human voice suppression processing is performed on the fourth audio frame to obtain the first gain, which is less than 1. In some implementations of the present application, if the interfering human voice presence information indicates that the frame does not belong to a pure interfering human voice frame, the first gain is set to 1.

In scenarios with multiple speakers, the second microphone indiscriminately captures speech from all individuals. Only the target human voice of the wearer is the desired signal. When only interfering human voices are present, suppressing them ensures correct output of the target human voice, maintaining call accuracy.

Step S10532: Perform nonlinear echo reduction processing on the fourth audio frame to obtain a second gain.

Nonlinear echo reduction processing is performed on the fourth audio frame, outputting the second gain.

Step S10533: Perform single-microphone noise suppression processing on the fourth audio frame to obtain a third gain.

Single-microphone noise suppression processing is performed on the fourth audio frame, outputting the third gain.

Step S10534: Determine a target gain based on the minimum value among the first gain, the second gain, and the third gain.

The minimum value among the first gain, second gain, and third gain is identified and set as the target gain. This effectively suppresses residual echo, noise, and interfering human voices in the fourth audio frame.

Step S10535: Adjust the fourth audio frame based on the target gain to determine the out-ear resultant sound signal.

In this implementation, Steps S10531 to S10533 do not involve actual adjustment of the fourth audio frame but only obtain corresponding gains. After determining the target gain in Step S10534, the gain of the fourth audio frame is adjusted according to the target gain. This eliminates environmental noise and interfering human voices in the external microphone signal without causing voice distortion due to over-suppression, thereby restoring clear target human voice and further improving the quality of the out-ear resultant sound signal.

In some implementations of the present application, the method further includes:
in a case where the noise presence information indicates that the frame does not belong to the pure noise frame, maintaining current adaptive filtering coefficients of the second audio frame unchanged; and
performing adaptive filtering processing on the second audio frame using the current adaptive filtering coefficients to obtain the fourth audio frame.

In this implementation, if the noise presence information indicates that the frame does not belong to a pure noise frame, it means the current audio frame contains target speech. In this case, the filtering coefficients of the current adaptive filter are maintained unchanged. Adaptive filtering processing is performed on the second audio frame using the adaptive filter to obtain the fourth audio frame, thereby avoiding voice distortion caused by erroneous processing.

In some implementations of the present application, after obtaining the third audio frame, the method further includes:
performing single-microphone noise suppression processing on the third audio frame; or performing residual nonlinear echo reduction processing on the third audio frame.

In this implementation, by performing single-microphone noise suppression processing on the third audio frame, residual noise in the third audio frame can be eliminated. By performing residual nonlinear echo reduction processing on the third audio frame, residual echo signals in the third audio frame can be eliminated.

In some implementations of the present application, the single-microphone noise suppression processing may employ Digital Signal Processing (DSP) noise reduction or neural network noise reduction. Since the third audio frame obtained after adaptive filtering processing has a relatively high signal-to-noise ratio, DSP noise reduction is generally sufficient.

In some implementations of the present application, the first microphone is a feedback microphone or a bone conduction microphone. Before performing adaptive filtering processing on the first audio frame based on the second audio frame to obtain the third audio frame, the method further includes:
when the first microphone is the feedback microphone, performing fixed filtering processing on the first audio frame using a fixed filter according to the second audio frame, and performing linear echo reduction processing on the fixed-filtered first audio frame, wherein coefficients of the fixed filter are generated from pure noise signals collected by the first microphone and the second microphone under different active noise cancellation modes;
when the first microphone is the bone conduction microphone, performing linear echo reduction processing on the first audio frame.

In this implementation, the feedback microphone has active noise cancellation functionality. If the first microphone is a feedback microphone, coefficients of the fixed filter are pre-generated using pure noise signals collected by the first microphone and the second microphone under different active noise cancellation modes (including transparency mode, noise reduction mode, and off mode). After obtaining the first audio frame, fixed filtering processing is performed on the first audio frame using the fixed filter according to the second audio frame, to eliminate external noise leaked into the first audio frame under different active noise cancellation modes. This ensures consistent signal-to-noise ratio of the first microphone across different active noise cancellation modes, particularly in transparency mode, so that call quality and auditory experience are not affected by active noise cancellation mode switching. Since the first microphone is positioned very close to the speaker, the collected echo signal is large and primarily consists of linear echoes. Performing linear echo reduction processing on the first audio frame eliminates most of these linear echoes.

The bone conduction microphone, namely Voice Pick-Up (VPU) microphone, is a bone conduction pickup microphone. If the first microphone is a bone conduction microphone, since bone conduction microphones are not affected by active noise cancellation modes, fixed filtering processing on the first audio frame is unnecessary. Linear echo reduction processing is performed on the first audio frame to eliminate most linear echoes.

To further illustrate the technical concepts of the present application, the technical solutions of the present application are described below in conjunction with specific application scenarios.

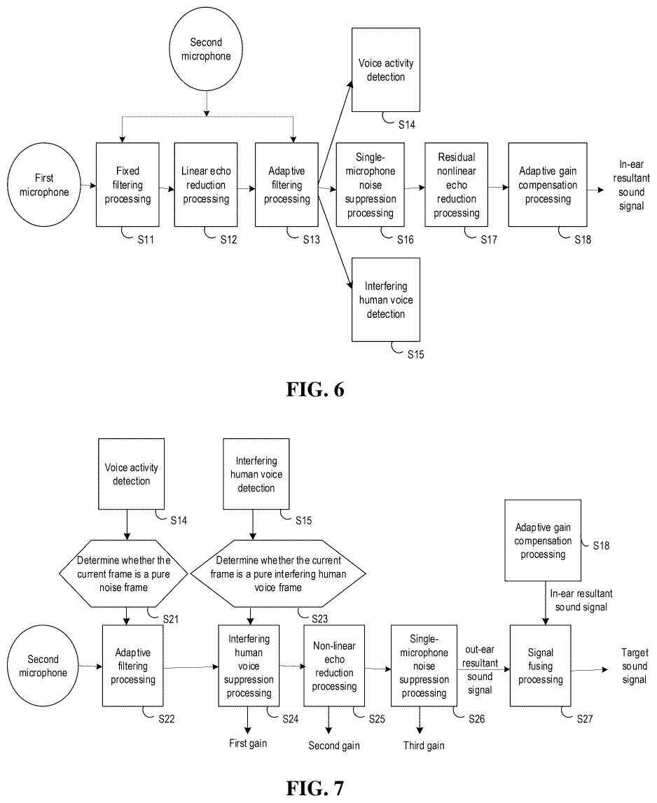

An implementation of the present application provides an earphone call noise reduction method. The earphone includes a first microphone and a second microphone. FIG. 6 illustrates a second flowchart of the earphone call noise reduction method according to an implementation of the present application. For the first microphone, as shown in FIG. 6, the method includes the following steps:

### Step S11: Fixed Filtering Processing.

In this implementation, the first microphone is a feedback microphone. Prior to Step S11, a first sound signal inside the human ear is obtained through the first microphone, and a second sound signal outside the human ear is obtained through the second microphone. The first sound signal and the second sound signal are respectively subjected to framing, windowing, or Fourier transform to convert them into the frequency domain, obtaining a first audio frame corresponding to the first sound signal and a second audio frame corresponding to the second sound signal.

Coefficients of a fixed filter are pre-generated using pure noise signals collected by the first microphone and the second microphone under different active noise cancellation modes (including transparency mode, noise reduction mode, and off mode). After obtaining the first audio frame, fixed filtering processing is performed on the first audio frame using the fixed filter according to the second audio frame, to eliminate external noise leaked into the first audio frame under different active noise cancellation modes. This ensures a consistent signal-to-noise ratio of the first microphone across different active noise cancellation modes, particularly in transparency mode, so that call quality and auditory experience are not affected by active noise cancellation mode switching.

### Step S12: Linear Echo Reduction Processing.

Since the first microphone is positioned very close to the speaker, the collected echo signal is large and primarily consists of linear echoes. Performing linear echo reduction processing on the first audio frame eliminates most linear echoes in the first audio frame.

### Step S13: Adaptive Filtering Processing.

In this implementation, based on the second audio frame, adaptive filtering processing is performed on the first audio frame through an adaptive filter to obtain a third audio frame. This dynamically adjusts the first audio frame according to the second audio frame, eliminating environmental noise leaked into the first microphone due to improper user wearing (or varying wearing tightness), thereby improving the signal-to-noise ratio of the first audio frame.

### Step S14: Voice Activity Detection.

Noise estimation may be performed on the third audio frame, and the frame voice presence probability of the third audio frame may be determined based on the noise estimation result. In some implementations, a neural network may be used to process the third audio frame to output a voice activity result and determine the frame voice presence probability of the third audio frame. Whether the current audio frame belongs to the pure noise frame can be determined based on the frame voice presence probability.

Step S15: Interfering human voice Detection.

A first auto-power spectral density corresponding to the third audio frame and a second auto-power spectral density corresponding to the second audio frame are determined. Whether the current audio frame belongs to a pure interfering human voice frame is determined based on the ratio between the first auto-power spectral density and the second auto-power spectral density. The first auto-power spectral density is the auto-power spectral density of the third audio frame within a target frequency range, and the second auto-power spectral density is the auto-power spectral density of the second audio frame within the target frequency range. This avoids calculating ratios for auto-power spectral densities outside the target frequency range, thereby reducing computational load and preventing misjudgments caused by high-frequency attenuation and noise in the first microphone's signal, significantly improving the accuracy of interfering human voice detection. Specifically, the ratio is determined using Formula 1, which is expressed as:

$$Energy\_diff = \frac{{\sum }_{{ω}_{2}}^{{ω}_{1}} {Φ}_{F B} ( ω )}{{\sum }_{{ω}_{2}}^{{ω}_{1}} {Φ}_{OUT} ( ω ) + δ}$$

where, Energy_diff represents the ratio, Φ_FB (ω) represents the first auto-power spectral density, Φ_OUT (ω) represents the second auto-power spectral density, and ω represents the angular frequency; δ is a small quantity greater than 0 to avoid division by zero; ω₁ and ω₂ represent the upper and lower limits of the target frequency range, respectively, with the minimum value of ω₁ being 0 and the maximum value of ω₂ being ½ of the FFT points.

The frame voice presence probability is compared with a first probability and a second probability, while the ratio is compared with a first ratio and a second ratio. If the frame voice presence probability is less than the first probability, it indicates a low probability of voice presence in the current frame, and thus the current audio frame is determined to be a pure noise frame. If the ratio is less than the first ratio, it indicates the absence of target human voice, and thus the current audio frame is determined to be a pure interfering human voice frame. If the frame voice presence probability is greater than the second probability and the ratio is greater than the second ratio, it indicates the presence of target human voice with minimal noise and interfering human voices, and thus the current audio frame is determined to be a target human voice frame.

### Step S16: Single-Microphone Noise Suppression Processing.

By performing single-microphone noise suppression processing on the third audio frame, residual noise in the third audio frame can be eliminated.

### Step S17: Residual Nonlinear Echo Reduction.

By performing residual nonlinear echo reduction processing on the third audio frame, residual echo signals in the third audio frame can be eliminated.

### Step S18: Adaptive Gain Compensation Processing.

In a case where the target human voice presence information indicates that the frame belongs to a target human voice frame, the voice presence probability of each frequency point in the third audio frame is determined. Frequency points with a voice presence probability greater than a third probability are identified as target frequency points. Adaptive gain compensation processing is performed on the target frequency points in the third audio frame based on the second audio frame to obtain an in-ear resultant sound signal. This automatically adjusts the gain of the target frequency points according to the frequency response characteristics of the second audio frame, maintaining the gain of the target frequency points at an appropriate level.

By identifying the target frequency points, amplification of noise frequency points in the third audio frame can be avoided. Applying adaptive gain compensation processing only to the target frequency points perfectly restores the natural timbre of the target human voice, thereby enhancing the user's call experience.

FIG. 7 illustrates a third flowchart of the earphone call noise reduction method according to an implementation of the present application. For the second microphone, as shown in FIG. 7, the method includes the following steps:

Step S21: Determine whether the current frame is a pure noise frame.

In this implementation, the current frame refers to the current audio frame. If the frame voice presence probability is less than a first probability, it indicates a low probability of voice presence in the current frame, and thus the current audio frame is determined to be a pure noise frame.

### Step S22: Adaptive Filtering Processing.

In a case where the noise presence information indicates that the frame belongs to the pure noise frame, adaptive filtering coefficients of the second audio frame are updated. Adaptive filtering processing is performed on the second audio frame using an adaptive filter with the updated adaptive filtering coefficients, thereby accurately and effectively filtering out noise in the second audio frame to obtain a fourth audio frame.

Step S23: Determine whether the current frame is a pure interfering human voice frame.

If the ratio is less than a first ratio, it indicates the absence of target human voice, and thus the current audio frame is determined to be a pure interfering human voice frame.

### Step S24: Interfering Human Voice Suppression Processing.

If the current audio frame is a pure interfering human voice frame, interfering human voice suppression processing is performed on the fourth audio frame to obtain a first gain, which is less than 1. In some implementations of the present application, if the current audio frame is not a pure interfering human voice frame, the first gain is set to 1.

### Step S25: Nonlinear Echo Reduction Processing.

Nonlinear echo reduction processing is performed on the fourth audio frame to output a second gain.

### Step S26: Single-Microphone Noise Suppression Processing.

Single-microphone noise suppression processing is performed on the fourth audio frame to output a third gain. In this step, single-microphone neural network noise reduction is generally employed.

The minimum value among the first gain, the second gain, and the third gain is determined and set as a target gain. The fourth audio frame is adjusted according to the target gain to determine an out-ear resultant sound signal, thereby effectively suppressing residual echo, noise, and interfering human voices in the fourth audio frame.

### Step S27: Signal Fusion Processing.

Signal fusion processing is performed on the in-ear resultant sound signal and the out-ear resultant sound signal. The result of the signal fusion processing is subjected to an inverse Fourier transform to obtain a target sound signal, thereby ensuring subsequent output of the target sound signal in the form of a time-domain signal.

The earphone call noise reduction method in the implementations of the present application effectively addresses issues such as noise leakage, timbre variation, and unstable auditory perception caused by variations in user wearing tightness, different Active Noise Cancellation (ANC) modes, and environmental noise changes when using the first microphone signal. It significantly improves the speech quality of the wearer's voice (including noise reduction level, voice clarity, stability, and naturalness). Specifically, the technical effects include:

1. The implementations of the present application utilize the first microphone to collect voice signals received inside the ear canal, isolating external environmental noise and achieving a high signal-to-noise ratio, which notably enhances voice clarity and intelligibility.

2. The implementations of the present application generate coefficients for a fixed filter using pure noise signals collected by the first microphone and the second microphone under different active noise cancellation modes. The fixed filter is then applied to the first microphone data to eliminate external noise leaked into the first microphone signal under different ANC modes. This ensures a consistent signal-to-noise ratio of the first microphone across different ANC modes (especially in transparency mode), thereby maintaining call quality and auditory stability unaffected by ANC mode switching.

3. The implementations of the present application perform linear echo reduction on the first microphone signal to ensure that even when the signal contains significant echo components, it does not affect the detection of the target voice signal.

4. The implementations of the present application apply adaptive filtering to the first microphone signal using noise signals collected by the second microphone. This eliminates environmental noise leaked into the first microphone due to improper user wearing (or varying wearing tightness), further enhancing the signal-to-noise ratio of the target signal in the first microphone signal.

5. The implementations of the present application perform voice activity detection on the first microphone signal after filtering and linear echo reduction to obtain the voice presence probability of the current audio frame. This ensures accurate voice activity detection even in noisy environments where the signal from the external microphone combination may be overwhelmed in noise.

6. The implementations of the present application use the energy ratio between the first microphone and the second microphone within a specific frequency band as a threshold to determine whether the current frame contains target human voice or only interfering human voices. This enables detection and suppression of interfering human voices, particularly those originating from directly in front of the user.

7. The implementations of the present application perform adaptive gain compensation on the first microphone signal using the second microphone signal to address auditory perception changes caused by the first microphone signal's characteristics, such as heavier low-frequency components and severe high-frequency attenuation. This ensures stable auditory perception and natural timbre of the target human voice in the uplink output after signal fusion, even under varying environmental noise conditions.

8. After processing, the first microphone signal is fused with the second microphone signal through signal fusion. This improves the clarity of the low-frequency band of speech under strong non-stationary noise conditions, such as heavy noise and wind noise, significantly enhancing speech intelligibility during calls.

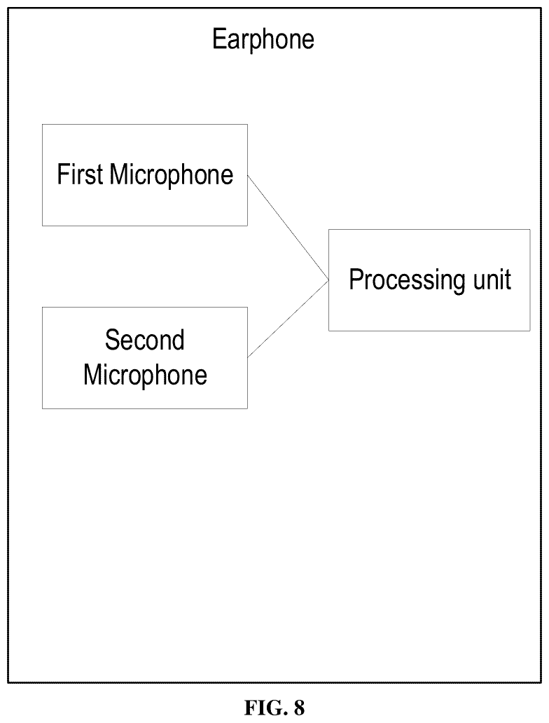

Implementations of the present application further provide an earphone. FIG. 8 illustrates a structural block diagram of an earphone according to an implementation of the present application. As shown in FIG. 8, the earphone includes: a first microphone configured to collect a first sound signal inside a human ear; a second microphone configured to collect a second sound signal outside the human ear; and a processing unit coupled to the first microphone and the second microphone, configured to execute the earphone call noise reduction method according to various implementations of the present application.

It is understandable that, in the implementations of the present application, the earphone may further include components such as a housing, a Bluetooth module, a memory, a speaker, etc., but these are not limiting.

In the aforementioned implementations, the methods may be implemented entirely or partially through software, hardware, firmware, or any combination thereof. When implemented using software, the methods may be entirely or partially implemented in the form of a computer program product. The computer program product includes one or more computer instructions. When the computer program instructions are loaded and executed on a computer, the processes or functions described in the implementations of the present application are generated entirely or partially. The computer may be a general-purpose computer, a special-purpose computer, a computer network, or other programmable devices. The computer instructions may be stored in a non-transitory computer-readable storage medium or transmitted from one computer-readable storage medium to another computer-readable storage medium. For example, the computer instructions may be transmitted from a website, computer, server, or data center to another website, computer, server, or data center via wired means (e.g., coaxial cable, optical fiber, digital subscriber line, etc.) or wireless means (e.g., infrared, wireless, microwave, etc.). The non-transitory computer-readable storage medium may be any available medium that can be accessed by a computer or a data storage device such as a server or data center that integrates one or more available media. The available medium may be a magnetic medium (e.g., floppy disk, hard disk, magnetic tape), an optical medium (e.g., DVD), or a semiconductor medium (e.g., solid-state drive), etc.

The above implementations are merely exemplary embodiments of the present application and are not intended to limit the present application. The scope of protection of the present application is defined by the claims. Those skilled in the art may make various modifications or equivalent replacements to the present application within the essence and protection scope of the present application, and such modifications or equivalent replacements should also be considered as falling within the protection scope of the present application.

The breadth and scope of the present disclosure should not be limited by any of the above-described exemplary implementations, but should be defined only in accordance with the following claims and their equivalents.

What is claimed is:

1. An earphone call noise reduction method, comprising:
acquiring a first sound signal inside a human ear through a first microphone of an earphone, and acquiring a second sound signal outside the human ear through a second microphone of the earphone;
performing target conversion processing on the first sound signal to obtain a first audio frame, and performing the target conversion processing on the second sound signal to obtain a second audio frame, wherein the target conversion processing comprises: framing, windowing, and Fourier transform;
performing adaptive filtering processing on the first audio frame based on the second audio frame to obtain a third audio frame;
adjusting the third audio frame according to attribute information of the third audio frame to obtain an in-ear resultant sound signal, wherein the attribute information comprises: noise presence information, interfering human voice presence information, and target human voice presence information;
adjusting the second audio frame according to the attribute information to obtain an out-ear resultant sound signal;
performing signal fusion processing on the in-ear resultant sound signal and the out-ear resultant sound signal; and
generating a target sound signal to be output based on a result of the signal fusion processing.

2. The earphone call noise reduction method according to claim 1, wherein:
the noise presence information comprises whether the frame belongs to a pure noise frame,
the interfering human voice presence information comprises whether the frame belongs to a pure interfering human voice frame, and
the target human voice presence information comprises whether the frame belongs to a target human voice frame;
wherein before adjusting the third audio frame according to the attribute information of the third audio frame, the method further comprises:
performing voice activity detection on the third audio frame to determine a frame voice presence probability corresponding to the third audio frame;
determining whether a current audio frame belongs to the pure noise frame based on the frame voice presence probability;
determining a first auto-power spectral density corresponding to the third audio frame and a second auto-power spectral density corresponding to the second audio frame;
determining whether the current audio frame belongs to the pure interfering human voice frame based on a ratio between the first auto-power spectral density and the second auto-power spectral density; and
determining whether the current audio frame belongs to the target human voice frame based on the frame voice presence probability and the ratio.

3. The earphone call noise reduction method according to claim 2, wherein:
the current audio frame belongs to the pure noise frame when the frame voice presence probability is less than a first probability;
the current audio frame belongs to the pure interfering human voice frame when the ratio is less than a first ratio;
the current audio frame belongs to the target human voice frame when the frame voice presence probability is greater than a second probability and the ratio is greater than a second ratio;
wherein the first probability is less than the second probability, and the first ratio is less than the second ratio;
the first auto-power spectral density is an auto-power spectral density of the third audio frame within a target frequency range; and
the second auto-power spectral density is an auto-power spectral density of the second audio frame within the target frequency range.

4. The earphone call noise reduction method according to claim 2, wherein adjusting the third audio frame according to the attribute information of the third audio frame comprises:
when the target human voice presence information indicates that the frame belongs to the target human voice frame, determining target frequency points among all frequency points in the third audio frame, wherein the target frequency points correspond to a voice presence probability greater than a third probability; and
performing adaptive gain compensation processing on the target frequency points in the third audio frame based on the second audio frame.

5. The earphone call noise reduction method according to claim 2, wherein adjusting the second audio frame according to the attribute information to obtain the out-ear resultant sound signal comprises:
when the noise presence information indicates that the frame belongs to the pure noise frame, updating adaptive filtering coefficients of the second audio frame;
performing adaptive filtering processing on the second audio frame using the updated adaptive filtering coefficients to obtain a fourth audio frame; and
determining the out-ear resultant sound signal based on the interfering human voice presence information and the fourth audio frame.

6. The earphone call noise reduction method according to claim 5, wherein determining the out-ear resultant sound signal based on the interfering human voice presence information and the fourth audio frame comprises:
when the interfering human voice presence information indicates that the frame belongs to a pure interfering human voice frame, performing interfering human voice suppression processing on the fourth audio frame to obtain a first gain;
performing nonlinear echo reduction processing on the fourth audio frame to obtain a second gain;
performing single-microphone noise suppression processing on the fourth audio frame to obtain a third gain;
determining a target gain based on a minimum value among the first gain, the second gain, and the third gain; and
adjusting the fourth audio frame based on the target gain to determine the out-ear resultant sound signal.

7. The earphone call noise reduction method according to claim 5, further comprising:
when the noise presence information indicates that the frame does not belong to the pure noise frame, maintaining current adaptive filtering coefficients of the second audio frame unchanged; and
performing adaptive filtering processing on the second audio frame using the current adaptive filtering coefficients to obtain the fourth audio frame.

8. The earphone call noise reduction method according to claim 1, wherein after obtaining the third audio frame, the method further comprises:
performing single-microphone noise suppression processing on the third audio frame; or
performing residual nonlinear echo reduction processing on the third audio frame.

9. The earphone call noise reduction method according to claim 1, wherein the first microphone is a feedback microphone or a bone conduction microphone, and wherein before performing adaptive filtering processing on the first audio frame based on the second audio frame to obtain the third audio frame, the method further comprises:
when the first microphone is the feedback microphone, performing fixed filtering processing on the first audio frame using a fixed filter according to the second audio frame, and performing linear echo reduction processing on the fixed-filtered first audio frame, wherein coefficients of the fixed filter are generated from pure noise signals collected by the first microphone and the second microphone under different active noise cancellation modes; or
when the first microphone is the bone conduction microphone, performing linear echo reduction processing on the first audio frame.

10. An earphone, comprising:
a memory storing computer-readable instructions; and
a processor coupled to the memory and configured to execute the computer-readable instructions, wherein the computer-readable instructions, when executed by the processor, cause the processor to perform operations comprising:
acquiring a first sound signal inside a human ear through a first microphone of the earphone, and acquiring a second sound signal outside the human ear through a second microphone of the earphone;
performing target conversion processing on the first sound signal to obtain a first audio frame, and performing the target conversion processing on the second sound signal to obtain a second audio frame, wherein the target conversion processing comprises: framing, windowing, and Fourier transform;
performing adaptive filtering processing on the first audio frame based on the second audio frame to obtain a third audio frame;
adjusting the third audio frame according to attribute information of the third audio frame to obtain an in-ear resultant sound signal, wherein the attribute information comprises: noise presence information, interfering human voice presence information, and target human voice presence information;
adjusting the second audio frame according to the attribute information to obtain an out-ear resultant sound signal;
performing signal fusion processing on the in-ear resultant sound signal and the out-ear resultant sound signal; and
generating a target sound signal to be output based on a result of the signal fusion processing.

11. The earphone according to claim 10, wherein:
the noise presence information comprises whether the frame belongs to a pure noise frame,
the interfering human voice presence information comprises whether the frame belongs to a pure interfering human voice frame, and
the target human voice presence information comprises whether the frame belongs to a target human voice frame;
wherein before adjusting the third audio frame according to the attribute information of the third audio frame, the operations further comprise:
performing voice activity detection on the third audio frame to determine a frame voice presence probability corresponding to the third audio frame;
determining whether a current audio frame belongs to the pure noise frame based on the frame voice presence probability;
determining a first auto-power spectral density corresponding to the third audio frame and a second auto-power spectral density corresponding to the second audio frame;
determining whether the current audio frame belongs to the pure interfering human voice frame based on a ratio between the first auto-power spectral density and the second auto-power spectral density; and
determining whether the current audio frame belongs to the target human voice frame based on the frame voice presence probability and the ratio.

12. The earphone according to claim 11, wherein:
the current audio frame belongs to the pure noise frame when the frame voice presence probability is less than a first probability;
the current audio frame belongs to the pure interfering human voice frame when the ratio is less than a first ratio;
the current audio frame belongs to the target human voice frame when the frame voice presence probability is greater than a second probability and the ratio is greater than a second ratio;
wherein the first probability is less than the second probability, and the first ratio is less than the second ratio;
the first auto-power spectral density is an auto-power spectral density of the third audio frame within a target frequency range; and
the second auto-power spectral density is an auto-power spectral density of the second audio frame within the target frequency range.

13. The earphone according to claim 11, wherein adjusting the third audio frame according to the attribute information of the third audio frame comprises:
when the target human voice presence information indicates that the frame belongs to the target human voice frame, determining target frequency points among all frequency points in the third audio frame, wherein the target frequency points correspond to a voice presence probability greater than a third probability; and
performing adaptive gain compensation processing on the target frequency points in the third audio frame based on the second audio frame.

14. The earphone according to claim 11, wherein adjusting the second audio frame according to the attribute information to obtain the out-ear resultant sound signal comprises:
when the noise presence information indicates that the frame belongs to the pure noise frame, updating adaptive filtering coefficients of the second audio frame;
performing adaptive filtering processing on the second audio frame using the updated adaptive filtering coefficients to obtain a fourth audio frame; and
determining the out-ear resultant sound signal based on the interfering human voice presence information and the fourth audio frame.

15. The earphone according to claim 14, wherein determining the out-ear resultant sound signal based on the interfering human voice presence information and the fourth audio frame comprises:
when the interfering human voice presence information indicates that the frame belongs to a pure interfering human voice frame, performing interfering human voice suppression processing on the fourth audio frame to obtain a first gain;
performing nonlinear echo reduction processing on the fourth audio frame to obtain a second gain;
performing single-microphone noise suppression processing on the fourth audio frame to obtain a third gain;
determining a target gain based on a minimum value among the first gain, the second gain, and the third gain; and
adjusting the fourth audio frame based on the target gain to determine the out-ear resultant sound signal.

16. The earphone according to claim 14, wherein the operations further comprise:
when the noise presence information indicates that the frame does not belong to the pure noise frame, maintaining current adaptive filtering coefficients of the second audio frame unchanged; and
performing adaptive filtering processing on the second audio frame using the current adaptive filtering coefficients to obtain the fourth audio frame.

17. The earphone according to claim 10, wherein after obtaining the third audio frame, the operations further comprise:
performing single-microphone noise suppression processing on the third audio frame; or
performing residual nonlinear echo reduction processing on the third audio frame.

18. The earphone according to claim 10, wherein the first microphone is a feedback microphone or a bone conduction microphone, and wherein before performing adaptive filtering processing on the first audio frame based on the second audio frame to obtain the third audio frame, the operations further comprise:
when the first microphone is the feedback microphone, performing fixed filtering processing on the first audio frame using a fixed filter according to the second audio frame, and performing linear echo reduction processing on the fixed-filtered first audio frame, wherein coefficients of the fixed filter are generated from pure noise signals collected by the first microphone and the second microphone under different active noise cancellation modes; or
when the first microphone is the bone conduction microphone, performing linear echo reduction processing on the first audio frame.

19. A non-transitory computer-readable medium storing instructions that, when executed by a processor, cause the processor to perform operations comprising:
acquiring a first sound signal inside a human ear through a first microphone of an earphone, and acquiring a second sound signal outside the human ear through a second microphone of the earphone;
performing target conversion processing on the first sound signal to obtain a first audio frame, and performing the target conversion processing on the second sound signal to obtain a second audio frame, wherein the target conversion processing comprises: framing, windowing, and Fourier transform;
performing adaptive filtering processing on the first audio frame based on the second audio frame to obtain a third audio frame;
adjusting the third audio frame according to attribute information of the third audio frame to obtain an in-ear resultant sound signal, wherein the attribute information comprises: noise presence information, interfering human voice presence information, and target human voice presence information;
adjusting the second audio frame according to the attribute information to obtain an out-ear resultant sound signal;
performing signal fusion processing on the in-ear resultant sound signal and the out-ear resultant sound signal; and
generating a target sound signal to be output based on a result of the signal fusion processing.

20. The non-transitory computer-readable medium according to claim 19, wherein the noise presence information comprises whether the frame belongs to a pure noise frame,
the interfering human voice presence information comprises whether the frame belongs to a pure interfering human voice frame, and
the target human voice presence information comprises whether the frame belongs to a target human voice frame;
wherein before adjusting the third audio frame according to the attribute information of the third audio frame, the operations further comprise:
performing voice activity detection on the third audio frame to determine a frame voice presence probability corresponding to the third audio frame;
determining whether a current audio frame belongs to the pure noise frame based on the frame voice presence probability;
determining a first auto-power spectral density corresponding to the third audio frame and a second auto-power spectral density corresponding to the second audio frame;
determining whether the current audio frame belongs to the pure interfering human voice frame based on a ratio between the first auto-power spectral density and the second auto-power spectral density; and
determining whether the current audio frame belongs to the target human voice frame based on the frame voice presence probability and the ratio.
